(19) United States
(12) Patent Application Publication
(10) Pub. No.: US 2020/0143986 A1
(43) Pub. Date: May 7, 2020

(54) METHOD FOR ELECTRICALLY CONNECTING A WIRE ELEMENT OF A STATOR WITH A CARRIER ELEMENT AND STATOR CONTROL SYSTEM

(71) Applicant: Vitesco Technologies GMBH, Hannover (DE)

(72) Inventor: Vlad Aronet, Bocsa (RO)

(73) Assignee: Vitesco Technologies GMBH, Hannover (DE)

(21) Appl. No.: 16/735,000

(22) Filed: Jan. 6, 2020

Related U.S. Application Data
(63) Continuation of application No. PCT/EP2018/061435, filed on May 3, 2018.

(30) Foreign Application Priority Data
Jul. 5, 2017 (EP) 17465527.4

(51) Int. Cl. H01F 41/10; H01F 5/04; H02K 3/52; H02K 5/02; H02K 5/22; H02K 11/30

(52) U.S. Cl. CPC H01F 41/10; H01F 5/04; H02K 3/522; H02K 2203/03; H02K 5/225; H02K 11/30; H02K 5/02

(57) ABSTRACT

A method for electrically connecting a wire element of a stator with a carrier element. The invention is characterized in that the wire element and the stator are covered by an overmolding, wherein at least one cavity is drilled through the overmolding and through the wire element of the stator such that the wire element is at least partially disrupted in at least one predetermined section. The carrier element is positioned on the overmolding of the stator such that a connection hole of the carrier element aligns with one cavity. The cavity and the connection hole are at least partially filled with an electrically conductive material. In sum an electrical contact is established between the carrier element and the wire element.

### CROSS-REFERENCE TO RELATED APPLICATIONS

This application claims priority to PCT Application PCT/EP2018/061435, filed May 3, 2018, which claims priority to European Patent Application No. EP 17465527.4, filed Jul. 5, 2017. The disclosures of the above applications are incorporated herein by reference.

### FIELD OF THE INVENTION

A method for electrically connecting a wire element of a stator with a carrier element. A stator control system including a stator and a carrier element.

### BACKGROUND OF THE INVENTION

A stator designed for an electrical machine usually includes a hollow-shaped cylindrical body designed to house a rotor capable of rotating around itself within the cylindrical body of the stator. The rotation of the rotor is driven by an electromagnetic field that is created within the body of the stator by a set of electromagnetic coils arranged within the stator. For this, at least one wire of the electromagnetic coils has to be wired around the body of the stator, wherein the at least one wire usually includes a beginning and an ending section where an electrical contact to an electric power source has to be made in order to provide an electric current to the electromagnetic coils.

In order to create the electrical contact, it is known to connect the wire of the stator for example to a contact ring by either welding or soldering the beginning or ending section of the wire extending outwards the stator to the contact ring. The contact ring may include a connector or an adapter where the contact ring is connected to the electric power source. Additionally, the stator may be indirectly connected to a printed circuit board by connecting the printed circuit board to the contact ring.

However, the process of connecting the stator to either the contact ring or the printed circuit board requires many intermediate steps and many electrical components. A stator connected to a printed circuit board results in being relatively large and therefore unpractical to be built into small designs, such as into actuators.

### SUMMARY OF THE INVENTION

It is therefore an object of the present invention to provide a method for electrically connecting a wire element of a stator with either a contact ring or a printed circuit board using a reduced number of steps, which results in a compact design of the stator with the contact ring or with the printed circuit board.

The object is accomplished by the subject matter of the independent claims. Advantageous developments with convenient and non-trivial further embodiments of the invention are specified in the following description, the dependent claims and the figures.

The invention is based on the realization that a combination of a stator with a contact ring or a combination of a stator with a printed circuit board is the most space-saving when the contact ring or the printed circuit board is directly placed on the stator such that a contact area between stator and contact ring or stator and printed circuit board is maximized and the overall volume of the respective combination is minimized. The contact ring is usually used as a supporting element for an adapter such that a part of a wire element of the stator is electrically connected via the contact ring to another electrical component that is connected to the adapter of the contact ring. A printed circuit board is generally known to be connected to a stator in order to direct and control an electric flow within the wire element of the stator. In this way, an electromagnetic field created by the wire element within the stator may be controlled and modified. In the following the contact ring and the printed circuit board are each denoted as a carrier element.

In known manner the wire element is wired around a body of the stator such that the wire element forms in parts at least one electromagnetic coil. The stator body exhibits for example a cylindrical shape. Several so-called stator teeth are arranged along a circumferential direction of the stator body. The wire element is wired around the teeth such that an electromagnetic coil is formed at each tooth. When the at least one electromagnetic coil is supplied with an electric current, an electromagnetic field is created within the stator. The wire element may form a continuous loop. Alternatively, the wire element may include a beginning and an ending section that is overlaid after the wiring around the body of the stator is finished.

The carrier element includes at least one electric component which supplies the at least one electromagnetic coil with the electric current when an electrical contact is established between the at least one electric component and the wire element. For example, if the carrier element is designed as a contact ring, the at least one electric component is designed as a plug connector. The at least one electric component may be designed for example as a capacitor or a resistor. The at least one electromagnetic coil is provided with the electric current when the wire element is electrically connected to the at least one electric component of the carrier element, given that the at least one electric component itself is supplied with the electric current.

The carrier element includes at least one planar surface. For example, the carrier element is flat in at least one spatial direction. The carrier element includes at least one connection hole through the at least one planar surface. The at least one connection hole may go through the entirety of the flat-shaped side of the carrier element. The connection hole may be conductive. For example, the connection hole is designed as a plated-through hole or as a so-called vertical interconnect access (via). When the wire element is connected to the connection hole, the electrical contact is established between the wire element and the connection hole. As a consequence, every electric component of the carrier element electrically connected to the connection hole is in electrical contact with the wire element.

According to the invention the wire element and the stator are at least partially covered by an overmolding such that the overmolding forms at least one planar surface. In other words, after the stator has been overmolded, at least one side of the stator includes a flat exterior surface. For example, the planar surface is formed at a front side of the stator. After the stator has been overmolded, the wire element may be entirely covered by a combination of the stator and the overmolding, such that no direct access to the wire element is made from an exterior side of the stator.

In order to connect the carrier element to the wire element of the stator, a hole is drilled through the overmolding in at least one predetermined location of the overmolding. The predetermined location is chosen such that the drilled hole goes through the wire element in at least one predetermined section of the wire element. The drilled hole forms a cavity on the surface of the overmolded stator that extends to the wire element. As a consequence, the wire element is at least partially disrupted in the at least one predetermined section. A potential flow of electric current through the wire element is interrupted because of the drilled hole. The wire element may also be completely cut through, in other words be entirely disrupted, because of the drilled cavity. The at least one cavity may form a blind hole or a stud hole. The at least one predetermined location on the overmolding may be determined such that the wire element is cut in a section of the wire element where it is not coiled. In other words, the predetermined section is chosen such that the at least one electromagnetic coil is not disrupted. For example, the at least one predetermined section is a section of the wire element in-between two stator teeth. The at least one cavity is drilled through the at least one planar surface of the overmolding. For example, the at least one cavity is drilled through the front side of the stator.

The carrier element with the at least one connection hole is positioned on the stator such that the at least one planar surface of the carrier element touches the at least one planar surface formed by the overmolding. At least one of the connection hole aligns with a cavity of the stator. Preferentially, the stator includes a number of cavities equal to a number of connection holes of the carrier element that are designed to be connected with the wire element of the stator. The predetermined locations for drilling the cavities are chosen such that when the carrier element is positioned on a surface of the stator, each cavity aligns with a corresponding connection hole. Preferentially, a diameter of the connection hole corresponds to a diameter of the cavity. The connection hole then overlays entirely the cavity.

Each of the at least one connection hole forms together with a corresponding cavity a cavity duct. According to the invention, each cavity duct is at least partially filled with an electrically conductive material. The cavity duct may also be entirely filled with the electrically conductive material. In sum, the electrical contact between the at least one electric component of the carrier element and the wire element in the at least one predetermined section is established. In other words, the electrically conductive material transmits the electricity applied on the connection hole to the wire element. The wire element is electrically connected again in the previously disrupted section. As a consequence, electricity may flow through the at least one electromagnetic coil and create an electromagnetic field.

The order of the steps according to the invention may be exchanged. For example, the carrier element may be first positioned on the overmolding of the stator and the at least one cavity is drilled through the connection holes on the overmolding. In another example the at least one cavity is drilled first and the carrier element is positioned afterwards. The electrically conductive material may be first introduced into the cavity and then the carrier element is positioned on the overmolding. In addition to the electrically conductive material, a fastening element like for example a screw is used to attach the carrier element to the stator. Alternatively, the conductive material forms together a piece that not only conducts electricity from the carrier element into the wire element, but also attaches mechanically the carrier element to the stator.

The advantage of the method according to the invention is that the carrier element may be attached to the wire element of the stator by means of one single intermediate connecting piece, which may be formed by the electrically conductive material. The carrier element is directly in touch with the overmolding of the stator, such that the combination of the carrier element with the stator takes up a minimal space. For example, if the stator is combined with a printed circuit board, no intermediate contact ring is required anymore to electrically connect the printed circuit board to the stator. Therefore, the combination of stator and carrier element may be implemented into small electrical machines, for example into a pump. The stator may be produced in one single piece with the overmolding without loose parts of the wire element extending outwards of the overmolding. A production of the stator and/or the combination of the stator with the carrier element is therefore more flexible and therefore production costs are minimized.

The invention also includes optional embodiments that provide features which afford additional technical advantages.

According to an embodiment of the invention, the at least one electric component of the carrier element is designed to control a flow of the electric current through the at least one electromagnetic coil. In other words, the at least one electric component is designed to decide whether the electric current should flow through the connection hole to the wire element in the predetermined section or whether this flow should stop. The at least one electric component may also control an intensity of the current. The at least one electric component is designed to control how electric current received from a power source is distributed to the various connection holes of the carrier element, such that the at least one electric component controls a distribution of the electric current to the different predetermined sections of the wire element. In this way, the carrier element may control to which electromagnetic coil the electric current is transferred. Therefore, the carrier element controls the electromagnetic field within the stator.

According to another advantageous embodiment of the invention, the wire element includes at least two electromagnetic coils and the at least one predetermined section is selected in-between two of the at least two electromagnetic coils. In other words, the at least one cavity is drilled through the surface of the overmolding in such a way that the wire element of the stator is at least partially disrupted in an intermediate section where two electromagnetic coils connect. For example, the previously mentioned stator teeth holding the electromagnetic coils are spaced apart from each other with a spacing. The stator body exhibits a groove located in this spacing. The intermediate section of the wire element which connects the two electromagnetic coils is inserted in this groove. This intermediate section of the wire element is then clearly identified when the stator and the wire element are covered by the overmolding. Consequently, when the cavity is drilled, one is certain that the drilling disrupts the wire element in the intermediate section between two coils. Preferentially, a cavity is drilled in-between each coil such that subsequently the flow of current through each electromagnetic coil is controlled individually by the carrier element. As a result, the electromagnetic field created by the electromagnetic coils inside the body of the stator is precisely shaped and designed.

According to another advantageous embodiment of the invention, the electrically conductive material includes an electrically conductive silicone. The cavity duct is filled entirely with the electrically conductive silicone. The electrically conductive silicone is inserted in the at least one cavity first and the carrier element is positioned afterwards on the overmolding of the stator. Additionally, further electrically conductive silicone is inserted into the at least one connection hole of the carrier element such that electricity is conducted from the connection hole to the wire element. Such an electrically conductive silicone is already commercially available, distributed for example by the company Shin-Etsu Silicone under the name KE-3492. The use of silicone is advantageous because it is flexibly applicable into the respective cavity duct. As a consequence, flexibility is allowed when drilling the cavity. A size and a dimension of the cavity and/or the cavity duct may vary without having an impact on the electrical conductivity realized by the electrically conductive silicone. The electrically conductive silicone is in a fluid state when inserted into the cavity duct such that the cavity duct is entirely filled by the silicone without leaving a gap. This allows a fast and flexible production of the stator and of a stator/carrier element system.

According to another advantageous embodiment of the invention, the electrically conductive material includes an electrically conductive rubber forming a connecting piece which connects the disrupted wire element with the connection hole of the carrier element. In other words, a connecting piece made of an electrically conductive rubber is inserted into the at least one cavity. The connecting piece may extend outwards the cavity of the stator and the carrier element is positioned on the overmolding of the stator such that each connecting piece pierces through one connection hole of the carrier element. The cavity duct is filled by both the electrically conductive silicone and the connecting piece formed by the electrically conductive rubber. Such an electrically conductive rubber is already commercially available, distributed for example by the company Holland Shielding under the name 5750-S. For example, a conductive filler is mixed into the rubber. The conductive filler may be for example Aluminum or Graphite. The advantage of using the electric conductive rubber is that a larger piece of the rubber may be cut into a smaller piece that precisely fits into the cavity duct. The size of the connecting piece made of the rubber is adapted to a size of the drilled cavity. A shape of the cavity may take therefore any shape. Preferentially, the shape of the cavity is such that an electrical contact surface between the wire element and the connecting piece and/or between the connecting piece and connection hole is large.

According to another advantageous embodiment of the invention, the electrically conductive material is provided at least in part by a self-tapping screw which extends from the disrupted wire element to the connection hole of the carrier element. After the carrier element is positioned on the stator, the self-tapping screw is screwed from the connection hole of the carrier element into the overmolding such that at least a screw tip of the screw is in contact with the wire element in the predetermined section. Preferentially, the self-tapping screw is screwed or drilled into the overmolding before the cavity in the overmolding is formed. In other words, the self-tapping screw forms the cavity in the overmolding the first time the screw is being screwed into the overmolding. Preferentially, the carrier element is connected to the wire element of the stator in one step as the screw is positioned through the connection hole of the carrier element and subsequently being screwed into the overmolding such that the screw at least partially disrupts the wire element in the predetermined section. The electrical contact is established then through the screw. This enables for a fast production of the stator/carrier element system.

Preferentially, the self-tapping screw features a press-fit connector onto which the connection hole of the carrier element is positioned. The press-fit connector is located on an opposite side of the tip of the screw. The press-fit connector is designed as a so-called press-fit pin. Preferentially, the self-tapping screw is screwed into the cavity of the overmolding of the stator such that the tip of the self-tapping screw connects the wire element in the disrupted section and such that the press-fit connector extends outwards the overmolding. The connection hole of the carrier element is then positioned onto the press-fit connector. This method features the advantage that the carrier element may be mounted subsequently to the stator. After construction of the stator/carrier element system the carrier element is removed easily and exchanged with another carrier element. This facilitates keeping for example the printed circuit board up-to-date to the latest technology. This equally facilitates maintenance and/or repair of the carrier element, as it is removed and put back onto the press-fit connector without removing the self-tapping screw.

According to another advantageous embodiment of the invention, the carrier element is designed as a printed circuit board. The printed circuit board is designed to control an electric flow within the wire element of the stator. The printed circuit board is designed to control which electromagnetic coil of the stator is being supplied with an electric current. In this way, an electromagnetic field created by the wire element within the stator is controlled and modified by the printed circuit board.

According to another advantageous embodiment of the invention, the carrier element is designed as a contact ring that includes at least one predefined contact element and a respective electric connection between one of the at least one connection hole and the contact element. For example, the contact element is designed as an electrical adapter.

The invention also relates to a stator control system that includes the previously described stator and the previously described carrier element. The stator control system is constructed by the combination of the stator with the contact ring. The stator control system may also be constructed by the combination of the stator with the printed circuit board.

The advantages described in regard to the method for electrically connecting a wire element of a stator with a carrier element according to the invention and its embodiments also apply correspondingly for the stator control system according to the invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the following an exemplary implementation of the invention is described. The figures show:

FIG. 1 a schematic illustration of a solely partially shown stator with a wire element forming electromagnetic coils;

FIG. 2 a schematic illustration of the solely partially shown stator where the wire element is disrupted in a predetermined section;

FIG. 3 a schematic illustration of the stator with an overmolding;

FIG. 4 a schematic illustration of the stator with the overmolding including several cavities;

FIG. 5 a schematic illustration of a close-up view of a cavity in the overmolding;

FIG. 6 a schematic illustration of a close-up view of another cavity in the overmolding;

FIG. 7 a schematic illustration of a stator control system including a stator and a printed circuit board;

FIG. 8 a schematic illustration of a solely partially shown printed circuit board with a connection hole;

FIG. 9 a schematic illustration of a sectional view of a cavity duct formed by the cavity of the overmolding of the stator and the connection hole of the printed circuit board;

FIG. 10 a schematic illustration of a schematic illustration of a sectional view of the cavity duct filled with an electrically conductive material;

FIG. 11 a schematic illustration of the stator where each cavity includes a connecting piece made of an electrically conductive rubber;

FIG. 12 a schematic illustration of a sectional view of the cavity duct filled with a self-tapping screw;

FIG. 13 a schematic illustration of the stator control system including self-tapping screws;

FIG. 14 a schematic illustration of a stator control system including a stator and a contact ring;

FIG. 15 a schematic illustration of a self-tapping screw with a press-fit connector;

FIG. 16 a schematic illustration of the stator where each cavity includes a connecting piece formed by the self-tapping screw with a press-fit connector;

FIG. 17 a schematic illustration of a sectional view of the cavity duct filled with the self-tapping screw with a press-fit connector; and

FIG. 18 a schematic illustration of the stator control system including self-tapping screws with respective press-fit connectors.

### DETAILED DESCRIPTION OF THE PREFERRED EMBODIMENTS

The following description of the preferred embodiment(s) is merely exemplary in nature and is in no way intended to limit the invention, its application, or uses.

The embodiments explained in the following are preferred embodiments of the invention. However, in the embodiments, the described components of the embodiments each represent individual features of the invention which are to be considered independently of each other and which each develop the invention also independently of each other and thereby are also to be regarded as a component of the invention in individual manner or in another than the shown combination. Furthermore, the described embodiments may also be supplemented by further features of the invention already described.

In the figures elements that provide the same function are marked with identical reference signs.

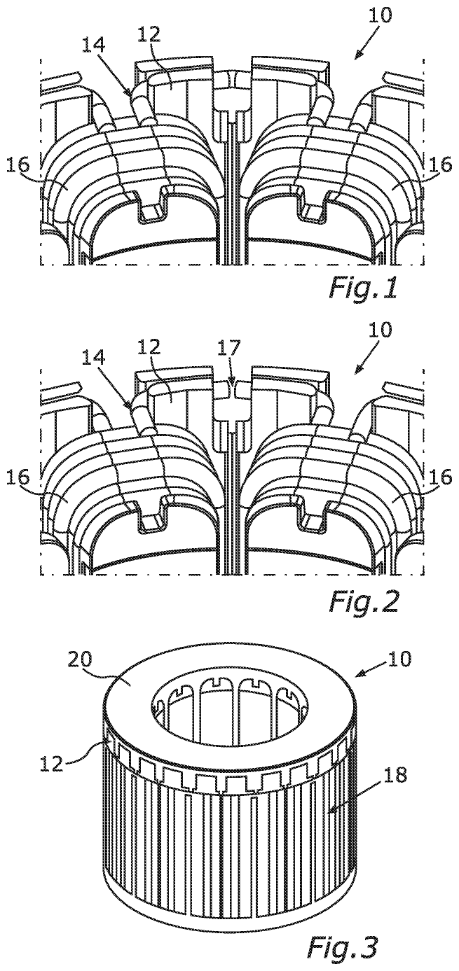

FIG. 1 shows a schematic illustration of a solely partially depicted stator 10, as it is known from prior art. The stator 10 includes a stator body 12 that is designed to feature along its circumferential direction several stator teeth extending inwards the stator body 12 in a known manner. Here shown are two stator teeth. Around each teeth of the stator body 12 a wire element 14 is coiled in such a way that an electromagnetic coil 16 is formed by the wire element 14 at a respective stator tooth. A front side of the stator body 12 features several spikes separated from each other by a spacing. The wire element 14 is wired such that each spike holds a section of the wire element 14. At each spike, the section of the wire element 14 is connected at one end with an electromagnetic coil 16 and at the other end with a further section of the wire element 14 that is hold by another spike. Therefore, the wire element 14 goes through every second spacing in-between the spikes. In total, the wire element 14 may form a continuous loop within the stator 10. Alternatively, the wire element 14 may include a beginning section and an ending section which may be overlaid with each other.

As shown in FIG. 2, according to the invention, the wire element 14 is at least partially disrupted in at least one predetermined section 17. Here shown the wire element 14 is entirely disrupted in the predetermined section 17. The predetermined section 17 is chosen such that the wire element 14 is disrupted in a section where the wire element 14 is in-between two spikes of the stator body 12. The wire element 14 is disrupted in-between every second spike of the stator body 12. In this way, each electromagnetic coil 16 is electrically separated from the other electromagnetic coils 16 of the stator 10.

According to the invention, before disrupting the wire element 14 as shown for example in FIG. 2, the stator body 12 and the wire element 14 are first covered with an overmolding 18 as it is known from prior art. According to the prior art, the beginning and/or the ending section of the wire element 14 extend through the overmolding 18. However, according to the invention, the wire element 14 is entirely covered by either the overmolding 18 or the stator body 12, such that at first no external access to the wire element exists, as it is shown in FIG. 3. The overmolding 18 is such that a planar surface 20 is formed by the overmolding 18 at the front side of the stator 10. The spikes of the stator body 12 are visible from an external point of view of the stator 10.

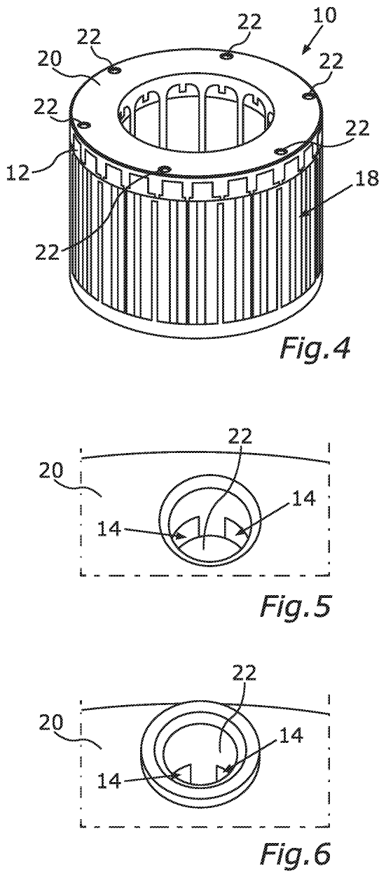

As shown in FIG. 4, several cavities 22 are drilled into the planar surface 20 of the overmolding 18 of the stator 10. Here are exemplary shown six cavities 22. The cavities 22 are drilled such that the drilling goes through the wire element 14 in the predetermined sections 17 of the wire element 14 located in-between two spikes. This is easily realized when the spikes of the stator body 12 are still visible after overmolding the stator 10. The cavities 22 may be round-shaped in a cross section of the cavity. Alternatively, the cross section of the cavities 22 may be rectangular-shaped. As shown in a close-up view of a cavity 22 in FIG. 5, the cavity 22 extends from the surface 20 of the overmolding 18 to at least the wire element 14 within the overmolding 18, such that the wire element 14 is at least partially disrupted in the predetermined section 17 shown in FIG. 2. Additionally, as shown in FIG. 6, the surface 20 of the overmolding 18 may include a dome-shaped elevation around a cavity 22.

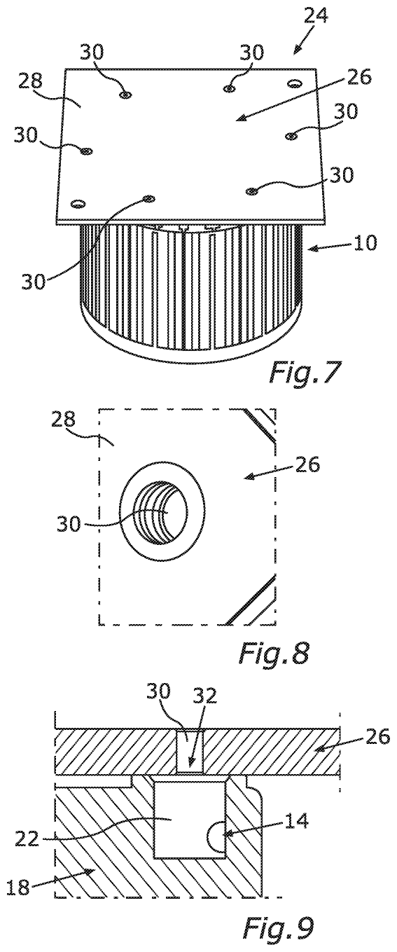

FIG. 7 shows a schematic illustration of a stator control system 24 including a stator 10 as described in FIG. 4 and a carrier element 26. As it is shown here the carrier element 26 is designed as a printed circuit board including at least one electrical component and at least one connection hole 30 for making an electrical contact with the at least one electrical component. The printed circuit board exhibits at least one planar surface 28. In known manner, the printed circuit board is flat-shaped and the at least one connection hole 30 extends through the flat-shaped surface 28, as is seen in a close-up view of a connection hole 30 of the printed circuit board in FIG. 8. The printed circuit board is placed on the overmolding 18 of the stator 10 such that a maximal surface area of the printed circuit board is in touch with the surface of the overmolding 18. For example, the planar surface 28 of the printed circuit board is placed on the planar surface 20 of the overmolding. The printed circuit board is therefore placed on the front side of the stator 10. The printed circuit board includes as many connection holes 30 as the overmolding 18 includes cavities 22. A spacing in between the connection holes 30 is chosen such that when the printed circuit board is positioned on top of the overmolding 18 with the cavities 22, all connection holes 30 align with one of the cavities 22.

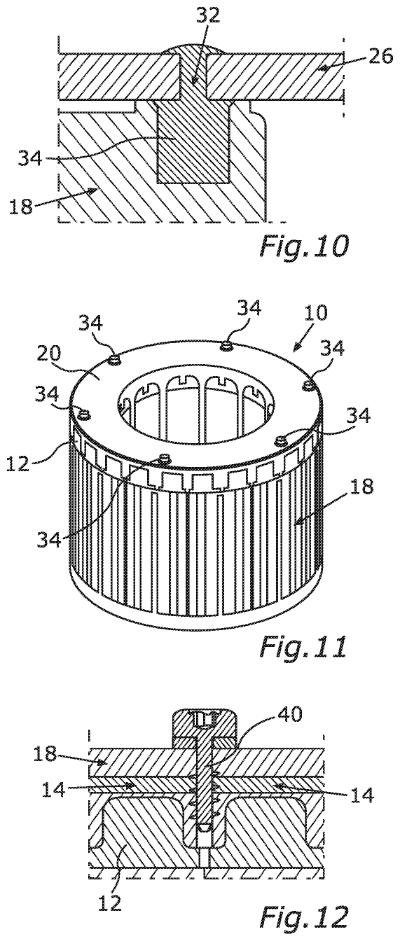

FIG. 9 shows a schematic illustration of a sectional view of a cavity duct 32 formed by the cavity 22 of the overmolding 18 of the stator 10 and the connection hole 30 of the printed circuit board. As is seen from FIG. 9, a cross-sectional diameter of the cavity 22 may differ from a cross-sectional diameter of the connection hole 30. The cavity duct 32 includes then different cross-sectional diameters. The cavity 22 extends through to the wire element 14. In a next step, as shown in FIG. 10, the cavity duct 32 is entirely filled with an electrically conductive material 34. For example, the electrically conductive material 34 is first in a fluid state when inserted into the cavity duct 32 and later brought into a solid-state for example by heating-up the stator. For example, the electrically conductive material 34 may be an electrically conductive silicone.

FIG. 11 shows the stator as in FIG. 4 but filled with an alternative electrically conductive material 34. In this embodiment, the cavities 22 are at first filled with the electrically conductive material 34 which forms a solid connecting piece 38. For example, the electrically conductive material 34 may be an electrically conductive rubber that is cut into a connecting piece 38 with a predetermined size and shape. The connecting pieces 38 made of rubber may entirely fill the cavity 22. The connecting pieces 38 extend from the wire element 14 outwards the cavity 22, such that the connection holes 30 of the carrier element 26 may be positioned on the connecting pieces 38 in a subsequent step.

FIG. 12 shows a schematic illustration of a sectional view of the cavity duct 32 filled with a self-tapping screw 40. In other words, a metal such as the self-tapping screw 40 is used as an electrically conductive material 34. After positioning the carrier element 26 on the overmolding 18, the self-tapping screw 40 is screwed into the overmolding 18 such that the self-tapping screw 40 extends from the wire element 14 through the connection hole 18. A head of the self-tapping screw 40 rests against the surface of the carrier element 26.

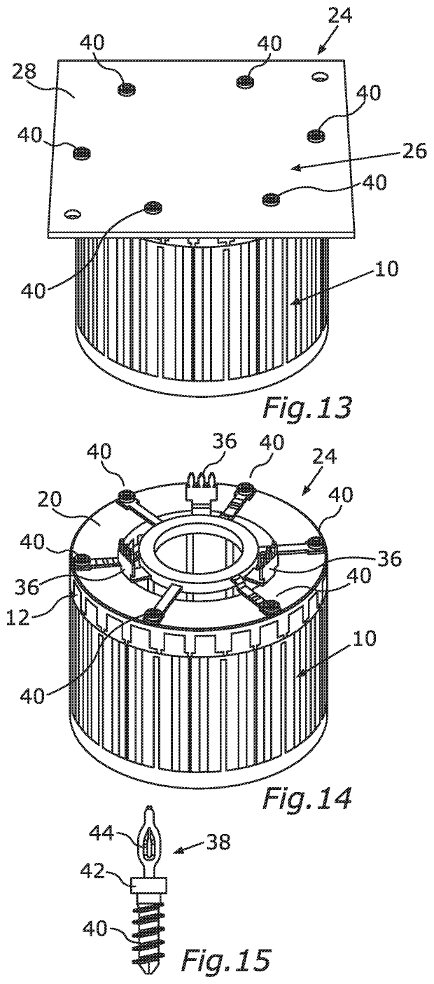

FIG. 13 shows the stator control system 24 where the carrier element 26 is designed as the previously mentioned printed circuit board. The cavities 22 are each filled with a self-tapping screw 40. The self-tapping screws 40 establish an electrical contact between the connection holes 30 of the printed circuit board and the wire element 14 as well as hold the printed circuit board firmly attached to the stator 10.

In FIG. 14, the carrier element 26 is designed as a contact ring instead of as a printed circuit board as in FIG. 13. The contact ring includes a ring-shaped a body and several extensions extending outwards from the ring-shaped body. The extensions are resting against the planar surface 20 of the overmolding 18. Each extension includes a connection hole 30 where the self-tapping screw 40 has been screwed through to reach and at least partially disrupt the wire element 14 inside the overmolding 18. The contact ring further includes here shown three adapters 36 having the function of an electrical connector where an external electricity supply is plugged in. The contact ring is entirely made of an electrically conductive material like a metal such that electricity received through the adapters 36 is transferred to the extensions and subsequently to the self-tapping screws 40 and to the wire element 14 inside the overmolding 18.

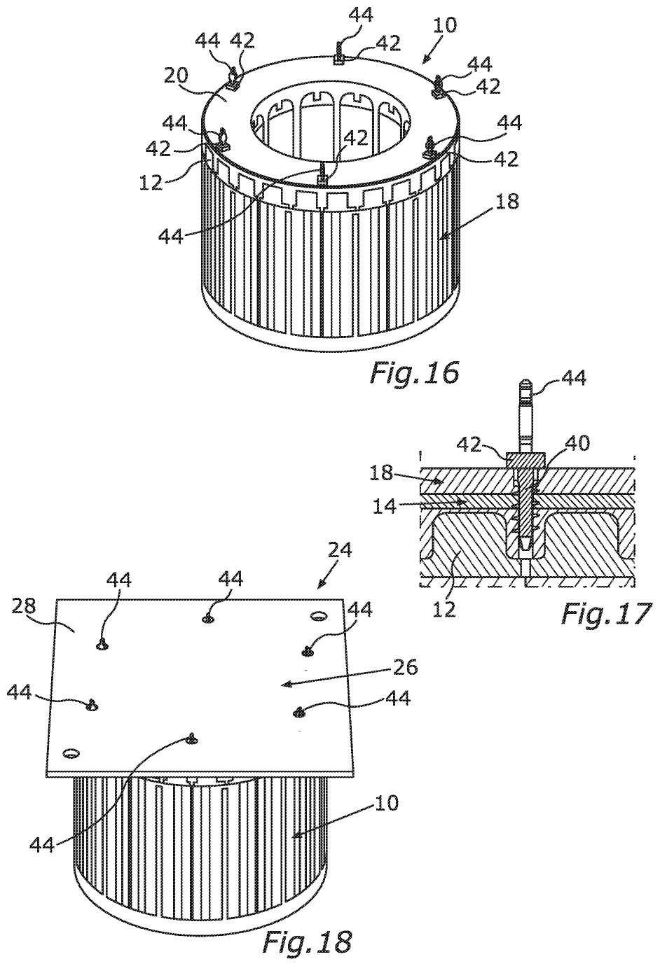

FIG. 15 shows a connecting piece 38 made of the electrically conductive material 34 according to another embodiment of the invention. The connecting piece 38 includes a self-tapping screw 40 as previously used and described for example in FIGS. 12, 13 and 14. The self-tapping screw 40 features a tip at one end and at an opposite end a screwing surface 42 where a screw driver or a screw driller may be applied to screw in the self-tapping screw 40. In addition to the screwing surface 42, the self-tapping screw 40 exhibits at its opposite end to the tip a press-fit connector 44. The press-fit connector 44 may be designed as a flat metal sheet. As shown in FIG. 16, the self-tapping screw 40 is screwed into the overmolding 18 such that the screwing surface 42 rests against the planar surface 20 of the overmolding 18 and such that the press-fit connector 44 extends outwards the overmolding 18. FIG. 17 shows a schematic illustration of a sectional view of the cavity duct 32 where the self-tapping screw 40 is inserted into the cavity 22 similar to FIG. 12, but additionally with the press-fit connector 44 attached to the self-tapping screw 40. Alternatively, the self-tapping screw 40 and the press-fit connector 44 form a single connecting piece 38. The press-fit connector 44 extends outwards the cavity 22 and potentially outwards the cavity duct 32 when the carrier element 26 is positioned on the overmolding 18 like shown in FIG. 18. Similar as for the embodiment shown in FIG. 13, the self-tapping screw 40 establishes an electrical contact between a connection hole 30 of the printed circuit board and the wire element 14 as well as firmly holds the printed circuit board attached to the stator 10. Due to the design and shape of the press-fit connector 44, the carrier element 26 is easily removed and placed back on the stator 10 without removing the self-tapping screw 40.

Overall, the examples show how a carrier element like a printed circuit board or a contact ring is electrically connected and mechanically attached to a stator of an electrical machine with few simple steps resulting in a simple composition.

The description of the invention is merely exemplary in nature and, thus, variations that do not depart from the gist of the invention are intended to be within the scope of the invention. Such variations are not to be regarded as a departure from the spirit and scope of the invention.

### REFERENCE SIGNS

10 stator
12 stator body
14 wire element
16 electromagnetic coil
17 predetermined section
18 overmolding
20 planar surface
22 cavity
24 stator control system
26 carrier element
28 planar surface
30 connection hole
32 cavity duct
34 electrically conductive material
36 adapter
38 connecting piece
40 self-tapping screw
42 screwing surface
44 press-fit connector

What is claimed is:

1. A method for electrically connecting a wire element of a stator with a carrier element, comprising the steps of:
providing a wire element;
providing at least one electromagnetic coil;
providing a carrier element;
providing at least one electric component being part of the carrier element;
providing at least one planar surface being part of the carrier element;
providing at least one connection hole which extends through the at least one planar surface;
forming at least a part of the at least one electromagnetic coil with the wire element;
creating an electromagnetic field within the stator when the at least one electromagnetic coil is supplied with an electric current;
supplying the at least one electromagnetic coil with the electric current from the at least one electric component when an electrical contact is established between the at least one electric component and the wire element;
at least partially covering the wire element and the stator with an overmolding such that the overmolding forms at least one planar surface;
drilling at least one cavity through the at least one planar surface of the overmolding and through the wire element of the stator such that the wire element is at least partially disrupted in at least one predetermined section of the wire element;
positioning the carrier element on the stator such that the at least one planar surface of the carrier element touches the at least one planar surface formed by the overmolding and such that each of the at least one cavity aligns with one of the at least one connection hole of the carrier element and forms together with the corresponding connection hole one single cavity duct;
at least partially filling each cavity duct with an electrically conductive material;
establishing the electrical contact between the at least one electric component and the wire element in the at least one predetermined section of the wire element.

2. The method of claim 1, further comprising the steps of controlling the flow of the electric current through the at least one electromagnetic coil with the at least one electric component.

3. The method of claim 1, further comprising the steps of:
providing at least two electromagnetic coils being part of the wire element;
selecting the at least one predetermined section in-between the at least two electromagnetic coils.

4. The method of claim 1, further comprising the steps of:
providing the electrically conductive material to be an electrically conductive silicone;
filling the cavity duct entirely with the electrically conductive silicone.

5. The method of claim 1, further comprising the steps of:
providing the electrically conductive material to be a connecting piece made of an electrically conductive rubber;
connecting the disrupted wire element to the connection hole using the connecting piece.

6. The method of claim 1, further comprising the steps of:
providing a self-tapping screw, the self-tapping screw being made of the electrically conductive material;
positioning the self-tapping screw into the cavity duct such that the self-tapping screw extends from the disrupted wire element to the connection hole of the carrier element.

7. The method of claim 6, further comprising the steps of:
providing a press-fit connector, the press-fit connector being part of the self-tapping screw;
positioning the connection hole of the carrier element onto the press-fit connector.

8. The method of claim 1, further comprising the steps of providing the carrier element to be printed circuit board.

9. The method of claim 1, further comprising the steps of:
providing the carrier element to be a contact ring; and
at least one predefined contact element being part of the contact ring;
electrically connecting one of the at least one connection hole and the at least one predefined contact element.

10. A stator control system comprising:
a stator for an electromagnetic machine, the stator further comprising:
a wire element;
at least one electromagnetic coil formed at least in part by the wire element, such that an electromagnetic field is created within the stator when the at least one electromagnetic coil is supplied with an electric current;
an overmolding which at least partially covers the stator and the wire element such that the overmolding forms at least one planar surface;
a carrier element, further comprising:
at least one electric component designed to supply the at least one electromagnetic coil with the electric current when an electrical contact is established between the at least one electric component and the wire element;
at least planar surface;
at least one connection hole extending through the at least one planar surface;
at least a partial disruption in at least one predetermined section of the wire element;
at least one cavity which extends through the at least one planar surface of the overmolding to the partial disruption of the wire element in the at least one predetermined section;
wherein the carrier element is positioned on the stator such that the at least one planar surface of the carrier element touches the at least one planar surface formed by the overmolding and such that each of the at least one cavity aligns with one of the at least one connection hole of the carrier element and forms together with the corresponding connection hole one single cavity duct, and each cavity duct is at least partially filled with an electrically conductive material which is designed to establish the electrical contact between the at least one electric component and the wire element in the at least one predetermined section of the wire element.
